(19) United States
(12) Patent Application Publication
(10) Pub. No.: US 2018/0204167 A1
(43) Pub. Date: Jul. 19, 2018

(54) SYSTEM AND METHOD FOR MANAGEMENT OF OPERATIONAL INCIDENTS BY A FACILITY SUPPORT SERVICE

(71) Applicant: Computacenter UK Ltd., Hatfield (GB)

(72) Inventors: Steve RAYNER, Hatfield (GB); Stephen KENNEDY, Hatfield (GB); Mark ANTELL, Hatfield (GB)

(21) Appl. No.: 15/922,690

(22) Filed: Mar. 15, 2018

Related U.S. Application Data
(63) Continuation of application No. PCT/GB2015/052679, filed on Sep. 16, 2015.

(51) Int. Cl. G06Q 10/06; G06Q 10/00; G06F 3/0481; G06F 17/18

(52) U.S. Cl. CPC G06Q 10/063114; G06F 17/18; G06F 3/04817; G06Q 10/20

(57) ABSTRACT

There is disclosed a computer-implemented incident management system comprising a first interface for receiving details of an incident, a ticketing module arranged to generate a first electronic ticket in accordance with said details received via the first interface, and a second interface for providing information relating to the incident to a user. The second interface provides the information relating to the incident in conjunction with an associated user input element and in response to activation of the associated user input element, the system forwards data identifying the user and the incident to the ticketing module. In response to receipt of said data identifying the user and the incident, the ticketing module is arranged to generate a second electronic ticket in association with the first electronic ticket.

### CROSS-REFERENCE TO RELATED APPLICATIONS

This application is a continuation of International Application No. PCT/GB2015/052679, filed Sep. 16, 2015. The above-referenced patent application is incorporated by reference in its entirety.

### BACKGROUND OF THE INVENTION

### Field of the Invention

The present invention relates to the management of operational incidents by a facility support service for an organisation. The invention has particular, but not exclusive, relevance to the management of information technology operational incidents.

### Description of the Related Technology

The operation of many organisations is dependent on Information Technology (IT). As such, the maintenance of the IT within an organisation in good working order is a high priority. This task is often handled by a dedicated IT support service, particularly for larger organisations. The IT support service can be provided internally within the organisation or outsourced to an external organisation.

An IT support service can operate a service desk and an electronic ticketing system. The service desk allows IT end users to interact with the IT support service. The service desk can include one or more of a telephone call centre, a web page and application software for a mobile device. As such, at least part of the service desk can be computer-implemented, requiring no involvement of IT technicians. For example, a computer-implemented function of a service desk may include a knowledge base that enables an end user to look up information on rectifying minor IT problems so that the IT technicians of the IT support service can concentrate on the more serious IT problems.

Another function of the service desk is to allow end users to report IT-related operational incidents to the IT support service. Such incidents can relate both to hardware devices and software. The IT incidents can relate to, for example, network connectivity, malfunctioning software and damaged hardware. The electronic ticketing system is used to document reported IT incidents. When an IT incident is reported to the IT support service, the electronic ticket system creates an electronic ticket for that IT incident. The electronic ticket includes details related to the IT incident, including for example the status of the electronic ticket, a description of the IT incident, the urgency of the IT incident, the severity of the IT incident, the location encountering the incident, attempted work-arounds or solutions, and any other relevant information. The electronic ticket system maintains a list of “open” or unresolved incidents, typically ordered by urgency. Electronic tickets are assigned in order from the list to IT support technicians within the IT support service so that the most urgent incidents are prioritised.

When an IT technician is assigned an IT incident to investigate, the corresponding electronic ticket is typically updated with the status of the electronic ticket being changed from “open” to “pending”. Upon resolution of the incident, the electronic ticket is again updated and the status of the ticket changed to “resolved”. Following resolution of an IT incident, the electronic ticket system typically stores the electronic ticket for future analysis. Such analysis can be both technical, e.g. an investigation into the cause of an incident and how the incident was resolved, and statistical, e.g. the effectiveness of the IT support service in responding to the incident, etc.

### SUMMARY

Certain examples described herein allow improvements in operating a facility support service. In particular, certain examples relate to the handling of major incidents which may affect a multitude of end users.

Certain examples use a ticketing module to generate an electronic ticket. The electronic ticket is generated in accordance with input details of an incident. The incident may be an IT incident. An example of an IT incident is a network outage. Other examples of an IT incident include the unavailability of one or more applications, slow network speeds, etc. Details of the incident can include one or more of a location of occurrence of the incident, a location of reporting of the incident, a severity of the incident, an assignment of the incident, and a status of the incident, according to certain examples. Said electronic ticket is referred to hereinafter as a “parent” ticket.

A first interface receives details of a reported incident. An example of a first interface is an electronic form on a web page. Other examples of a first interface include interactive voice response (IVR) functionality provided via a telephone system, a mobile application, a text messaging function, etc. The first interface forwards the received details to the ticketing module.

Certain examples use a second interface to provide information relating to a reporting incident to users of the support service. The information providing details of a reported incident is provided in conjunction with a user input element. An example of the second interface is a web page. Further examples of the second interface are an IVR system and a graphical user interface provided by a mobile application. An end user can interact with the second interface via a user computing device, e.g. a desktop computer, a laptop computer, a tablet device and a mobile telephone. If the user interface is a graphical interface, then the user input element can be a graphical control element in the form of, for example, a button, an icon or a hyperlink. Alternatively, if the second interface is an IVR system, the user input element can involve the speech recognition of an utterance or word. In an example graphical user interface, the user input element can be activated by moving a cursor over the user input element and clicking a mouse button. Touching a subarea of a touch-sensitive display is another example of user input, wherein the user input element, e.g. an icon, is located in said subarea.

Activation of the user input element notifies the support service that a user of a computing device is affected by the reported incident associated with the user input element. This prompts the forwarding of data identifying the user and the incident to the ticketing module. In response to receiving that data, the ticketing module is arranged to generate an electronic ticket. The generated electronic ticket is associated with the original, parent ticket. The generated electronic ticket is referred to hereinafter as a “child” ticket. The data comprising the child ticket is based at least in part on data comprising the parent ticket. The child ticket is associated with a particular user computing device, e.g. the device which transmits the signal, based on user input at the graphical control element, to the second interface. The child ticket comprises data relating to one or more of: an identifier of the user of the corresponding computing device, an identifier of the associated parent ticket, a date and/or time of generation of the child ticket, and a status of the IT incident associated with the parent ticket.

In some examples, when the ticketing module performs an action in relation to the parent ticket, which may be initiated by a user input, then the ticketing module automatically performs a corresponding action on each child ticket associated with the parent ticket. For example, when the status of a parent ticket is updated, the status of each associated child ticket is automatically updated. The status update can comprise, for example, information indicating that an IT incident is resolved or is being addressed. Further, when a message is sent to an end user associated with a parent ticket, the ticketing module can automatically transmit a signal to the end user associated with each associated child ticket. In one example, the end user receives the message from the ticketing module via an email. In other examples, the end user receives the message from the ticketing module via one or more of a push notification, an SMS message, an automated telephone call, and a graphical user interface provided by a mobile application.

Certain examples described herein allow system downtime, and the costs associated with downtime, to be reduced. Child tickets are usable for the gathering of statistical data relating to the IT problem. For example, a child ticket generated for each affected user provides an indication of the number and location of affected users for a particular problem. Such data is usable for analysing the IT problem, e.g. analysing the severity of the problem, the root cause of the problem, etc. An improved analysis of the severity of the problem enables the resolution of the problem to be suitably prioritised. Suitable prioritisation of the problem ensures that the problem is resolved as quickly as possible. Gaining an understanding of the root cause of the problem increases the likelihood that the problem will not recur in future.

Certain examples described herein enable an improvement in the efficiency of operating an IT support service. Child tickets are updated and affected users informed automatically in response to the updating of an associated parent ticket. The number of tickets requiring a manual update is therefore reduced. This is particularly advantageous in the scenario of a major IT incident affecting a large number of end users. Each user who reports that they are affected by the major incident causes a separate child ticket to be generated. All of the child tickets associated with a given parent ticket are updated simultaneously in response to an update of the parent ticket. Additionally, by providing users with a fast, simple method of informing the IT support service that the users are affected by a known IT incident, the number of telephone calls reporting the same incident is reduced. Support service telephone lines are therefore provided with an improved capacity for handling calls reporting different, previously unreported, incidents.

Certain examples described herein enable an improved user experience when encountering an IT problem. The graphical control element provides a quick, simple method for the user to inform the IT support service that the user is affected by a previously reported IT problem. The need for making time-consuming telephone calls to the support service is therefore reduced. In some examples, the child ticket generated based on the user's input is sent to the user. The user is therefore informed that the support service is aware of the user's being affected by the problem. Furthermore, the user, following the generation of a child ticket, receives automatic updates from the support service regarding the problem. The user is therefore proactively informed when the problem has been resolved, ensuring that downtime is kept to a minimum.

Further features and advantages of the invention will become apparent from the following description of embodiments of the invention, given by way of example only, which is made with reference to the accompanying drawings.

### BRIEF DESCRIPTION OF THE DRAWINGS

FIG. 1 is a schematic diagram showing the main components of an incident management system according to an example;

FIG. 2 is a schematic diagram showing a set of system components for a system comprising an incident management system according to an example;

FIG. 3 is a schematic diagram showing a graphical user interface associated with a ticket system according to an example;

FIG. 4 is a schematic diagram showing a data structure for a ticket system according to an example;

FIG. 5 is a flow chart showing a computer-implemented method of generating electronic tickets according to an example;

FIG. 6 is a schematic diagram showing a set of system components for a mobile computing device according to an example;

FIG. 7 is a flow chart showing a computer-implemented method of operating a mobile computing device according to an example.

FIG. 8 is a schematic diagram showing a set of system components for an incident management system according to an example.

### DETAILED DESCRIPTION OF CERTAIN INVENTIVE EMBODIMENTS

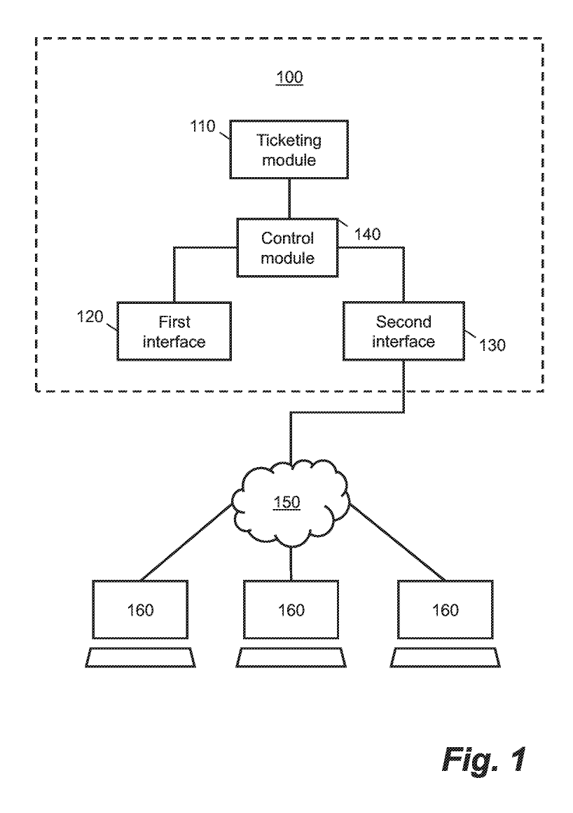

FIG. 1 shows an incident management system 100 used by an IT support service to manage IT operational incidents. In this example, the incident management system 100 includes a ticketing module 110, a first user interface 120, a second user interface 130 and a control module 140. The incident management system 100 communicates, via a network 150, with a plurality of user computing devices 160 within an organisation, each user computing device 160 being associated within the incident management system 100 with one or more end users.

The first user interface 120 allows details of an IT operational incident to be input to the incident management system 100. In this example, the first user interface 120 is provided via a computing device operated by a member of the IT support services team as an administration console. An end user telephones or emails the member of the IT support services team to report an IT operational incident, and the member of the IT support services team enters details of the IT operational incident into the administration console.

The second user interface 130 allows an end user to view information from the IT support service, and also allows an end user to provide information to the IT support service. In this example, the second user interface 130 has two alternative forms: a web page for the IT support services hosted by a web server and a graphical interface presented by a downloadable mobile application in communication with a mobile platform within the incident management system 100. The web page is viewed on a computing device 160 of the end user (e.g. a laptop computer, tablet computer, mobile telephone, etc) using a web browser. The mobile application is a dedicated application downloaded onto a mobile device, such as a cellular telephone.

The network 150 provides a communication link between the second user interface 130 and the user computing devices 160 of the end users. When the incident management system 100 is located remotely from the user computing devices 160, which will often be the case when the organisation outsources IT support services, then the network 150 typically includes a leased line between the premises of the organisation and the premises of the IT support services. When the incident management system 100 is located local to the user computing devices 160, then the network 150 may be a local Intranet.

The first user interface 120 and the second user interface 130 are connected to the control module 140, which processes data input via the first user interface 120 and the second user interface 130 and provides data for output via the first user interface 120 and the second user interface 130. The control module 140 is also connected to a ticketing module 110.

The ticketing module 110 generates and manages an electronic ticket for a reported IT incident in accordance with input details, i.e. details input via the first user interface 120 as discussed above. The electronic ticket is a machine-readable data structure storing information relating to the reported IT incident. The information in the electronic ticket can include one or more of the identity of the reporter of the incident, the severity of the incident, an assignment of the incident, and a status of the incident. The electronic ticket is generated with a unique reference identifier, and is stored in a memory.

In accordance with the invention, information about an incident entered into the incident management system 100 using the first user interface 120 can be displayed to end users via the second user interface 130 in conjunction with a graphical input element. If the end user is affected by the incident, then the end user can activate the graphical input element, which automatically triggers the generation of an electronic ticket linked to the electronic ticket for the corresponding displayed incident.

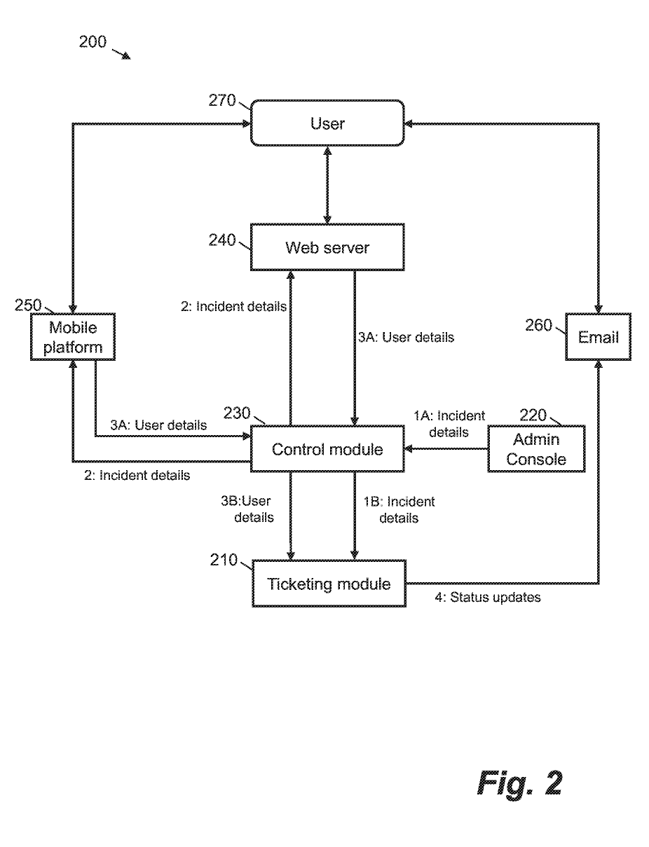

The management of an operational incident by the incident management system 100 will now be described with reference to FIG. 2, which shows components of the incident management system 200, which corresponds to the incident management system 100 of FIG. 1.

In this example, an administration console 220 is used by a member of the IT support services team and provides the first user interface by which details for an IT incident reported via telephone or email by an end user are entered into the incident management system 200. The incident details are forwarded to the control module 230, which in turn forwards the incident details to a ticketing module 210. Following receipt of the incident details, the ticketing module 210 generates an electronic ticket for the IT incident. The ticketing module assigns a reference number to the electronic ticket, and advises the control module 230 of that reference number.

In this example, the control module 230 also determines if the IT incident is a “major incident” using a set of incident criteria, including an assessment the ability of the IT incident to affect significant numbers of end users or customers and whether the cost of rectifying the IT incident is likely to be high. If the control module 230 determines that the IT incident is a major incident, then the control module 230 sends data to the web server 240 and the mobile platform 250 (that provide data for alternative forms of the second user interface of FIG. 1) for displaying details of the major incident to the end user. In accordance with the present invention, the control module 230 also sends instructions for displaying a graphical input element in conjunction with the major incident details to the web server 240 and the mobile platform 250. An end user 270, using a computing device, is able to access the information of the major incident by either using a web browser to access the web page maintained by the web server 240 or by using a mobile application to access the graphical interface provided by a mobile application in communication with the mobile platform 250.

In order to access the second user interface, whether via the web page or the mobile application, a user first performs a logon operation. This logon operation can be manual, e.g. the user enters a username and password each time a logon operation is performed, or automatic, e.g. a user computer automatically fills in a username and password that has been previously stored. In this way, the incident management system is able to identify the user, and also cross-reference the user identity to various data recorded, for example in a registration process, for the user. This data can include the location of the user and details of IT hardware devices and software used by the user.

The graphical input element enables the end user to indicate to the control module 230, by activating the graphical input element, whether or not the IT incident affects that end user. Following a user activating the graphical input element displayed on a web page managed by the web server 240, the web server 240 sends a signal to the control module 230 identifying the IT incident and the identity of that user. Similarly, in response to a user activating the graphical input element within a mobile application, the mobile platform 250 sends a signal identifying the IT incident and the identity of that user.

Following receipt of a signal identifying an IT incident and the identity of the user, the control module 230 accesses the electronic ticket corresponding to the IT incident (hereafter referred to as the parent electronic ticket) and activates an option to generate a related electronic ticket (hereafter referred to as the child electronic ticket). In particular, the child electronic imports details of the IT incident from the parent electronic ticket, and includes details of the end user that activated the graphical input element. Further, the new child electronic ticket is added to a list of child electronic tickets associated with that parent electronic ticket stored in an incidents association table. Subsequently, when changes are made to the parent electronic ticket (e.g. a change to the status of the parent electronic ticket), corresponding changes are made to each child electronic ticket provided in that list. Further, the ticketing module 210 also sends status updates to the end users associated with the parent electronic ticket and the child electronic tickets on the list by at least one of an email and a mobile push notification.

A parent electronic ticket in combination with associated child electronic tickets provide data relating to the IT incident that can have several purposes. For example, by identifying the locations of the users corresponding to the parent electronic ticket and the multiple child electronic tickets, a profile of the spread of the incident can be created and displayed to an IT technician as a report, a data table, or a graphical representation such as a map, etc. The generation of such an impact profile improves the speed and accuracy of the IT technician in identifying a fix to resolve the incident and/or the cause of the incident. Alternatively, data relating to several reported incidents can be analysed by an IT technician to identify an underlying problem that causes the reported incidents. Further, the data can be used in the assessment as to whether service requirements contracted by the IT support service are fulfilled.

### Example Graphical User Interface

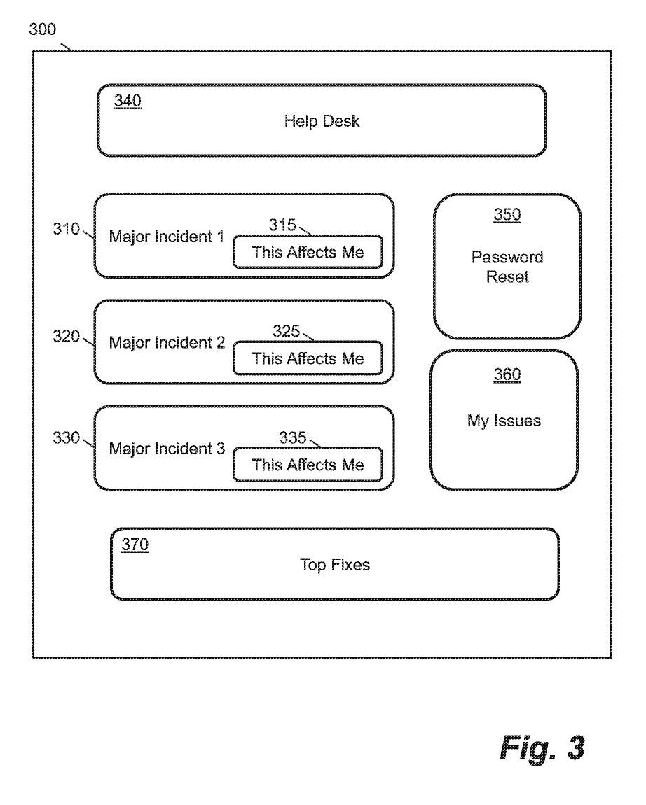

FIG. 3 shows a schematic illustration of a graphical user interface (GUI) 300 used by an incident management system according to an example. The GUI 300 can be displayed as either a web page via the web server 240 of FIG. 2 or by a mobile application in communication with a mobile platform in the incident management system.

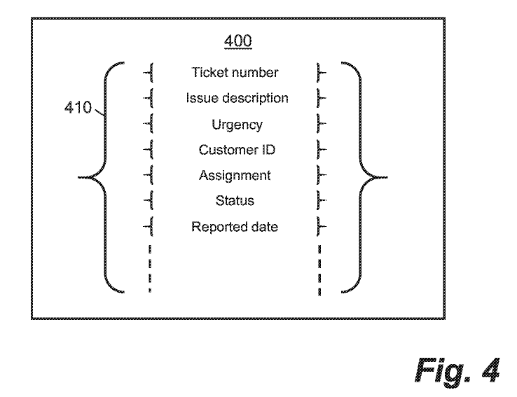

The GUI 300 has a plurality of incident display areas 310, 320, 330 associated with reporting details of major incidents. Although three such incident display areas are shown in the example of FIG. 4, any number of incident display areas may be used, including a single incident display area. The incident display areas 310, 320, 330 each provide a description of the given IT incident. In some examples, the description gives one or more of a location of the given IT incident, a date and/or time of reporting of the given IT incident and an identifier of the given IT incident. A reference code is an example of such an identifier.

Each of the incident display areas 310, 320, 330 of the GUI 300 has a sub-area 315, 325, 335 that forms a graphical input element suitable for user input. The graphical input element within a given incident display area is associated with the IT incident corresponding to said that incident display area. For example, the graphical input element of subarea 315 is associated with a first IT incident, details of which are displayed in incident display area 310. In one example, display subareas 315, 325, 335 each comprise one or more icons identifying a graphical input element. In this example, each graphical input element is in the form of a button with the legend “This Affects Me”.

User actuation of a graphical control element of a given display subarea, e.g. by positioning a cursor over the graphical control element and ‘clicking’ using a mouse device or pressing the enter/return key, or by pressing the corresponding display sub-area on a touch-sensitive screen, causes a signal to be sent to the control module 230 indicating that the user is affected by the associated IT incident. For example, a user actuates a graphical input element at subarea 325 in order to indicate that the user is affected by the IT incident described in display area 320, i.e. Major Incident 2. In this example, following activation of the graphical input element for an incident by a user, the graphical input element displayed to that user is deactivated to prevent repeat entries.

In addition to incident display areas 310, 320, 330, the GUI 300 has further display areas 340, 350, 360, 370 that provide links to information and/or interactive content relating to users of the IT support system. In this example:
the display area 340 provides a link to a help desk;
the display area 350 provides a link to reset a password;
the display area 360 provides a user-specific list of reported incidents; and
the display area 370 provides a link to a list of IT-related fixes.

### Example Electronic Data Structures

FIG. 4 shows an electronic data structure 400 for an electronic ticket in the incident management system. The electronic ticket can be a parent electronic ticket or a child electronic ticket. In FIG. 4, the electronic data structure 400 includes data elements 410 set out in accordance with a defined template. The electronic data structure 400 is generated and populated by the ticketing module 110 of FIG. 1 in response to details of a reported IT problem being received. The data elements 410 comprise a plurality of incident-specific data fields and user-specific data fields. Each incident-specific data field provides information relevant to the tracking, assigning and/or resolving of the reported IT problem. In FIG. 4, the data elements 410 comprise fields including “ticket number”, “issue description”, “urgency”, “customer ID”, “assignment”, “status”, “customer site”, “incident type”, “date of reporting”, “submitter”, etc. In addition to incident-specific data fields, the data elements 410 also comprise one or more user-specific data fields 420, such as “user identifier”. Other fields are used in various other examples. At least a portion of said data fields are filled upon generation of the electronic data structure 400. One or more of said fields can be left unfilled. One or more of the entered values of one or more of the incident-specific data fields can be changed after the generation of the electronic data structure 400. In other words, the electronic data structure 400 is configured to be updated with new and/or amended data elements over time.

When a child electronic ticket is generated and is associated to a parent electronic ticket, the values of certain incident-specific data fields are duplicated from the associated parent electronic ticket. For example, the fields “issue description”, “assignment” and “status” are included in the data structures of both parent and child tickets. In addition, one or more user-specific data fields of the data structure of the child ticket are filled, e.g. “user identifier”. The data elements of the data structure of the child ticket can also include one or more fields which associate the child ticket with a parent ticket, e.g. “parent number” or “associated incident”. The child ticket is linked to the parent ticket such that the data structure of the child ticket is updated with new and/or amended data elements in response to the data structure of the parent ticket being updated with new and/or amended data elements. Automated updating of a child ticket is implemented through the use of an incident associations table. When a child ticket is generated and is associated to an existing parent ticket, a record is created in the incident associations table. The incident associations table is then used by a ticketing system, e.g. the ticketing module 110, to ensure that all relevant data updated on the parent ticket is propagated to each of the associated child tickets.

Parent and child electronic tickets conforming to the electronic data structure 400 are stored in a non-transitory computer-readable storage medium such as volatile memory, non-volatile memory and magnetic or solid state storage, amongst others.

### Example Method of Generating Tickets

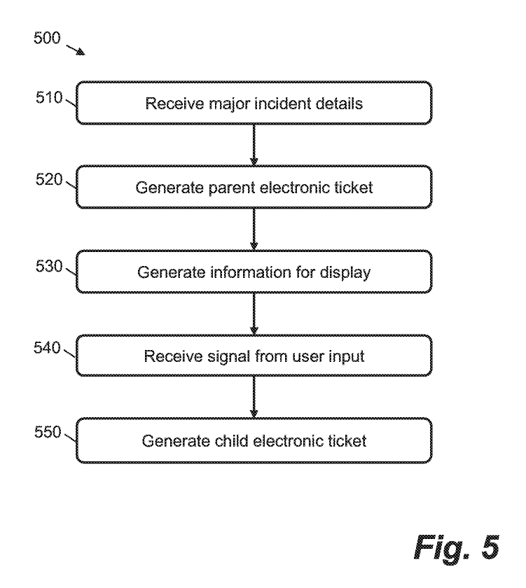

FIG. 5 shows a method 500 for generating electronic tickets. In an example, the method 500 is performed by the components of the incident management system 100, i.e. the ticketing module 110, the first user interface 120, the second user interface 130 and the control module 140. In certain other examples, the method 500 is performed by any other suitable computing device.

At block 510, details of a major incident are received, the major incident being a reported IT incident. The details of the major incident are entered via a first user interface, e.g. an electronic form according to one example. The user entering the details of the major incident can be, for example, an IT support technician or an end user. In other examples, the details of the major incident are entered without specific user input. According to one such example, the details are generated in response to the major incident being automatically detected.

At block 520, an electronic ticket is generated in accordance with input details of the major incident. The electronic ticket is a parent electronic ticket. The parent electronic ticket is associated with the major incident and is used in accordance with a ticketing system to manage, assign and/or track the ongoing status of the major incident. The parent ticket is configured to be able to be updated when the status of the major incident changes or when new details of the major incident are obtained.

At block 530, information is generated for display to users of the IT support service. Said information is displayed via a second interface, e.g. a web page or portal graphical user interface generated by a mobile application. In the case that the second user interface is a web page, users view the displayed information on a web browser of a computing device. In the case that the second user interface is a graphical user interface generated by a mobile application, users view the displayed information by activating the mobile application on a mobile telephone or the like. The generated information provides details of a reported major incident in conjunction with a graphical control element for user input. The graphical control element is displayed in a same display region as that which contains the displayed details of the major incident, according to certain examples. A plurality of display regions, each containing details of a separate major incident and a graphical control element, are displayed simultaneously, in certain cases.

At block 540, a signal is received, the signal corresponding to a user input via a graphical control element. The signal, being sent from a user device displaying the information regarding the major incident via the second interface, is used to derive data indicating that the user of said user device is affected by the particular major incident.

At block 550, an electronic ticket is generated in association with the electronic ticket generated at block 520. The electronic ticket generated at block 550 is a child electronic ticket. The child electronic ticket is generated in response to receiving an indication, via the signal at block 540, that the user is affected by the major incident.

### Example Mobile Computing Device

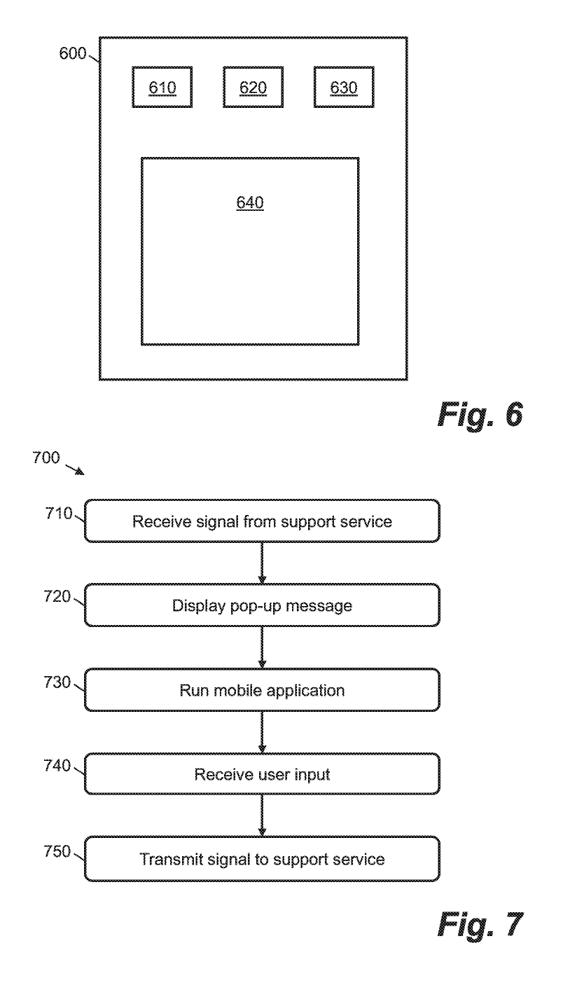

FIG. 6 shows a mobile computing device 600 according to an example. In certain examples, the mobile computing device 600 is a cellular telephone. Other examples of mobile computing devices include tablet devices, laptop devices and personal digital assistants (PDAs). The mobile computing device 600 is capable of running a plurality of mobile applications, sometimes simply referred to as “apps”. One or more applications are pre-installed on the mobile computing device 600. Further applications can be downloaded onto the mobile computing device through an application distribution platform, such as the Apple App Store, Google Play, Windows Phone Store, etc.

The mobile computing device 600 comprises a display 640. In the example of FIG. 6, the display 640 is touch-sensitive and is capable of receiving user input, e.g. by touching, tapping or gesturing with fingers and/or other suitable equipment such as a stylus. The mobile computing device can additionally have a keyboard or keypad for receiving user input. The mobile computing device 600 also has:
a receiver 610 that can receive signals from remote network devices, such as the incident management system 100, via a wireless local area network (WLAN) or a Public Land Mobile Network (PLMN);
a processor 620; and
a transmitter 630 that can transmit signals to remote network devices, such as the incident management system 100, via a wireless local area network (WLAN) or a Public Land Mobile Network (PLMN).

The mobile device 600 stores a mobile application for interacting with the incident management system 100. The mobile application can be either pre-stored or downloaded onto the mobile computing device 100. The user of the mobile device 600 can run the mobile application, in which case the mobile application takes advantage of the native resources of the mobile computing device 600. When the mobile application is running, data can be downloaded from and uploaded to the incident management system 100. When the mobile application is not running, the incident management system 100 can communicate to the mobile computing device 600 using push notifications, emails and SMS messages.

When the mobile application is run, a GUI as shown in FIG. 3 is displayed to the user on the display 640. FIG. 7 shows a method 700 of operating the mobile computing device 600. At block 710, a signal from an IT support service is received from the incident management system 100 alerting the user of the mobile computing device 600 of a new major incident. In an example, the signal is a “push” notification.

At block 720, a pop-up message is displayed to the user of the mobile computing device 600 giving details of the major IT incident derived from the signal received at block 710. On viewing the message, the user of the mobile computing device can run, at block 730, the mobile application, which cause a GUI as shown in FIG. 3 to be displayed to the user. If the user presses one of the graphical control elements, using the touchscreen functionality of the mobile computing device, then at block 740 a signal is transmitted to incident management system 100 that prompts the incident management system to generate a child electronic ticket.

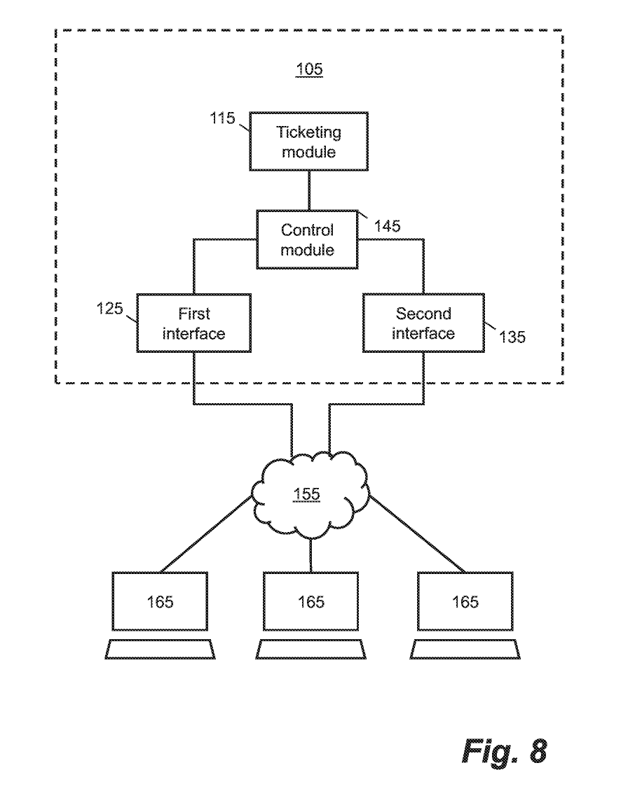

FIG. 8 shows example components of a mobile device 800, which is arranged to implement certain examples described herein. A processor 810 of the mobile device 800 is connectably coupled to a computer-readable storage medium 820 comprising a set of computer-readable instructions 830 stored thereon, which are executable by the processor 810. The computer-readable instructions 830 are integrated into a mobile application, e.g. an “app”. The mobile application can be pre-installed on the mobile device 800, can form part of the operating system of the mobile device 800, or can be downloaded onto the mobile device 800 through an application distribution platform, such as the Apple App Store, Google Play, Windows Phone Store, etc.

The mobile application formed from the computer-readable instructions 830 can be run in an active state, e.g. as a foreground application, and in an inactive state, e.g. as a background application. When run in the active state, the mobile application is given access to the native resources of the mobile computing device 800. Said native resources include one or more of hardware resources, software resources, operating system resources and network resources. The mobile application interacts with said resources via a set of pre-configured routines and/or protocols, e.g. application program interfaces (APIs). When run in the active state, the mobile application provides visual content to a user of the mobile device 800 via a display, and can interact with the user by receiving user input via a user interface. As explained above, the mobile device 800 can comprise a touch-sensitive screen which provides both user interface and display functionality. The mobile application can communicate and co-operate with a management server provided by an incident management system, such as the incident management system 100. In particular, the mobile application causes data to be downloaded from and uploaded to the incident management system 100. Data can be downloaded from the incident management system when the mobile application is run in the active state. Further data can be stored by the mobile application in the memory of the mobile device 800.

A user of the mobile device 800 can trigger the mobile application to run in the active state by selecting a graphical icon associated with the mobile application. The graphical icon is displayed to the user via a list of downloaded and/or pre-installed mobile applications. The graphical icon can also be displayed to the user via a pop-up message triggered by the receipt of a push notification. The push notification is used to enable the user to receive information from the incident management system while the mobile application is running in the inactive state and/or while the mobile application is not running at all. The push notification is sent from a push notification service in response to the push notification service receiving a request from the incident management system. The request contains information for inclusion in the push notification and one or more user identifiers and/or addresses for the intended recipient(s) of the push notification. In one example, receipt of the push notification by the mobile device 800 automatically causes the mobile application to run in the active state.

When the mobile application is run in the active state for the first time, e.g. after a user downloads the application onto the mobile device 800, the user is prompted to register and/or confirm certain details relating to a unique user profile. The user profile is used to identify the user to the incident management system. Certain aspects of the mobile application can be customised based on one or more of the preferences of a user, the characteristics of the mobile device 800 and the unique user profile. Such aspects include display language, frequency of receiving incident-related updates, visual characteristics of the user interface, etc.

Instruction 840 instructs the processor 810 to obtain details of a reported IT incident. The details can be in the form of a data structure comprising one or more discrete data fields. The details are obtained via a first signal received over a network from an incident management system, e.g. the incident management system 100. The first signal can be sent from the incident management system directly, e.g. from a management server, or via a third party server, e.g. a server of a push notification service. Instruction 850 instructs the processor 810 to display to a user of the mobile device 800 the details of the reported IT incident according to a pre-defined visual template. The pre-defined visual template defines how information received from the incident management system is displayed. The visual template can be integrated into a graphical user interface defined and employed by the mobile application, for example the graphical user interface 300. The details of the reported IT incident can be displayed in a variety of languages. The processor 810 is further instructed to display said details in conjunction with a graphical control element for receiving user input. The graphical control element is displayed using the pre-defined visual template. Instruction 860 instructs the processor 810 to transmit a second signal to the incident management system in response to user input via the graphical control element. The second signal comprises information identifying the user of the mobile device 800. The second signal is used by the incident management service to generate a child electronic ticket. The processor can be further instructed to ensure that the second signal is transmitted only once for a given user and a given reported incident, e.g. by inhibiting the transmission of further signals to the incident management system in response to a repeated occurrence of user input at the graphical control element.

The application can be further configured to obtain status updates relating to the reported incident from the incident management system and display said updates to the user. The updates can be displayed on the graphical user interface according to the pre-defined visual template, when the mobile application is running in the active state. When the mobile application is running in the inactive state, the updates can be displayed to the user via a pop-up message.

The processor 810 can include a microprocessor, microcontroller, processor module or subsystem, programmable integrated circuit, programmable gate array, or another control or computing device. The computer-readable storage medium 820 can be implemented as one or multiple computer-readable storage media. The computer-readable storage medium 820 can include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. The computer-readable instructions 830 can be stored on one computer-readable storage medium or on multiple computer-readable storage media.

### Modifications and Further Embodiments

In the incident management system of FIG. 1, the first interface uses an administrative console that is not directly linked by a network connection to an end user computing device. Alternatively, the first user interface could be incorporated in a website or a mobile application as shown in FIG. 9.

FIG. 8 shows an issue management system 105 used for generating electronic tickets in an IT support service, according to an example. The issue management system 105 is shown to illustrate a possible variation of the incident management system 100 of FIG. 1. As with FIG. 1, the incident management system 105 of FIG. 9 comprises a ticketing module 105, a first interface 125, a second interface 135 and a control module 145. The incident management system 105 is arranged to communicate via a network 155 with a plurality of user computing devices 165.

In FIG. 8, the first interface 125 receives details of a reported IT issue from one or more end users. A user of one of more of the user computing devices 165 notices or detects an IT incident. The user reports the IT incident to the issue management system 105 by entering details of the IT incident directly into the first interface 125. In the example shown in FIG. 9, one or more of the user computing devices 165 enter the details of the IT incident via the network 155 into the first interface 125. In this case, sending the details can involve completing an electronic form on a web page or a mobile application, for example. Once the details of the IT incident are received by the first interface 125, the incident management system 105 functions similarly to the issue management system 100 described in relation to FIG. 1.

The first interface, which is used for reporting an incident, can take many forms. For example, the first interface could be in the form of a web page managed by the IT support services and accessible to end users. Alternatively, the first interface could be in the form of a graphical user interface displayed by a mobile application in communication with a mobile platform forming part of the incident management system. In another example, the first interface could be formed by an interactive voice response (IVR) system employing speech recognition, in which case the end user calls a telephone number to report an IT incident.

Similarly, the second interface, that is used to display details of a reported incident in conjunction with a user input element, can take many forms. For example, the second interface could be an IVR system which recites details of reported incidents and a user either presses a key or utters a word or phrase to indicate that a reported incident affects them.

It is envisaged that the technique of the present invention will typically be applied to major IT incidents. In an example, an IT technician has the final say as to whether a reported IT incident is a major IT incident. Further, in an example an IT technician enters the information relating to the IT incident that is to be displayed to end users via a third interface interface. Accordingly, data relating to an incident reported via the first interface can be displayed to an IT technician via the third interface. The third interface includes an input mechanism that allows the IT technician to specify the information to be broadcast to end users via the second interface.

The issue management system can store language preferences for each end user. The data about a reported incident may therefore be displayed to each end user in their preferred language, if such a translation is available. Translations can be either generated manually or electronically.

Although the illustrated examples relate to IT support services, it will be appreciated that the present invention can also be applied to other types of facility support service. For example, the present invention could also be applied to building maintenance.

Systems as described are in some examples implemented by way of a computer program product comprising instructions for performing any of the previously described computer-implemented methods when loaded into system memory and processed by one or more processors. The system memory and one or more processors are comprised within a computer system device, such as a desktop or laptop computer for example. The instructions comprise computer program code written in at least one computer programming language. Said computer program code is encoded within at least one data file that is stored in volatile memory comprised within the system memory of the computer system device. In certain cases associated with this embodiment, the computer program comprising the instructions are recorded on a computer-readable storage medium. Such a computer-readable storage medium comprises, for example, one of magnetic, optical or tape media, a compact disc (CD), a digital versatile disc (DVD), or a data storage device such as a flash memory drive with an integrated Universal Serial Bus (USB).

The above examples are to be understood as illustrative. Further examples are envisaged. It is to be understood that any feature described in relation to any one example may be used alone, or in combination with other features described, and may also be used in combination with one or more features of any other of the examples, or any combination of any other of the examples. Furthermore, equivalents and modifications not described above may also be employed without departing from the scope of the invention, which is defined in the accompanying claims.

What is claimed is:

1. A computer-implemented incident management system comprising:
a first interface for receiving details of an incident;
a ticketing module arranged to generate a first electronic ticket in accordance with said details received via the first interface; and
a second interface for providing information relating to the incident to a user,
wherein the second interface is arranged to provide said information in conjunction with an associated user input element,
wherein in response to activation of said associated user input element, the system is arranged to forward data identifying the user and the incident to the ticketing module, and
wherein in response to receipt of said data identifying the user and the incident, the ticketing module is arranged to generate a second electronic ticket in association with the first electronic ticket.

2. The system according to claim 1, wherein the user input element is a graphical control element.

3. The system according to claim 1, wherein the incident is an information technology incident.

4. The system according to claim 3, further comprising a diagnostic module operable to process said first electronic ticket and said second electronic ticket to determine diagnostic information relating to said incident.

5. The system according to claim 4, wherein said diagnostic information provides location information indicative of the extent of the incident.

6. The system according to claim 1, wherein each of the first and the second electronic tickets has a plurality of data fields, and wherein the ticketing module is arranged to populate one of more of the data fields of the second electronic ticket using data entries for corresponding data fields of the first electronic ticket.

7. The system according to claim 1, wherein the first interface comprises a web page comprising an electronic form.

8. The system according to claim 1, wherein the second interface comprises a web page for displaying the reported information technology incident and the user input control element.

9. The system according to claim 1, wherein the second interface comprises a mobile platform for communicating said information relating to said incident to a mobile application.

10. The system according to claim 1, wherein the first electronic ticket comprises a data field storing a unique identifier and a data field storing status data.

11. The system according to claim 10, wherein the second electronic ticket comprises a data field storing the unique identifier for the first electronic ticket.

12. The system according to claim 1, wherein the ticketing module is further configured to:
obtain a status update associated with the first electronic ticket; and
transmit a signal to at least one computing device, the signal comprising data indicative of the status update.

13. The system according to claim 1, further comprising a statistical processing module to process the first and second electronic tickets wherein the second electronic ticket is usable for the gathering of statistical information relating to the information technology incident.

14. A computer-implemented method of operating a ticket system for a facility support service, the method comprising:
receiving details of a reported incident;
generating a first electronic ticket in accordance with input details of the incident;
providing information for display to users of the facility support service, wherein the generated information provides details of said reported incident in conjunction with a user input element; and
in response to a signal corresponding to user activation of the user input element, generating a second electronic ticket in association with the first electronic ticket.

15. The method of claim 14, further comprising processing the first electronic ticket and the second electronic ticket to determine diagnostic information relating to said reported incident.

16. The method of claim 15, wherein the diagnostic information is indicative of the location affected by the reported incident.

17. The method according to claim 14,
wherein said reported incident is an information technology incident,
wherein the first electronic ticket comprises a unique identifier and a status, and
wherein the first electronic ticket further comprises data relating to at least one of a description of the information technology incident, a location of the information technology incident, a date and/or time of reporting of the information technology incident, a severity of the information technology incident, and an urgency of the information technology incident.

18. The method according to claim 14, further comprising:
obtaining a status update associated with the first electronic ticket;
initiating a status update in accordance with the second electronic ticket; and
transmitting a signal to at least one computing device, the signal comprising data indicative of the status update of the second electronic ticket.

19. A mobile computing device comprising:
a receiver arranged to receive a signal from an information technology support service;
a processor arranged to derive from said signal details of a reported information technology incident and to provide said details for display to a user of the mobile computing device in conjunction with a graphical control element for user input; and
a transmitter arranged to transmit a signal to a ticket system of the information technology support service in response to receiving user input via the graphical control element.

20. The mobile computing device according to claim 19, wherein the signal received by the receiver comprises a push notification.
